(19) United States
(12) Patent Application Publication
(10) Pub. No.: US 2025/0191378 A1
(43) Pub. Date: Jun. 12, 2025

(54) METHOD FOR TRAINING A MACHINE LEARNING MODEL FOR SEMANTIC SCENE UNDERSTANDING

(71) Applicant: Robert Bosch GmbH, Stuttgart (DE)

(72) Inventor: Lukas Enderich, Berlin (DE)

(21) Appl. No.: 18/964,757

(22) Filed: Dec. 2, 2024

(30) Foreign Application Priority Data
Dec. 8, 2023 (DE) 10 2023 212 400.9

(51) Int. Cl. G06V 20/58; G06N 3/045; G06N 3/096; G06V 10/774; G06V 20/70

(52) U.S. Cl. CPC G06V 20/58; G06N 3/045; G06N 3/096; G06V 10/774; G06V 20/70

(57) ABSTRACT

A method for training a machine learning model for semantic scene understanding. The method includes: providing training data, wherein the training data comprise image information that represents a respective scene of the surroundings, wherein the image information results from a variety of image sensor sources in order to show the surroundings with different views in the image information for the representation of the respective scene; training the machine learning model based on the provided training data to ascertain semantic scene information; providing the trained machine learning model.

### CROSS REFERENCE

The present application claims the benefit under 35 U.S.C. § 119 of German Patent Application No. DE 10 2023 212 400.9 filed on Dec. 8, 2023, which is expressly incorporated herein by reference in its entirety.

### FIELD

The present invention relates to a method for training a machine learning model for semantic scene understanding. The present invention also relates to a machine learning model, a computer program, a device and a storage medium for this purpose.

### BACKGROUND INFORMATION

Deep neural networks (DNNs) have a strong ability to abstract data and they outperform classic methods in many areas of machine learning, such as computer vision, object detection or speech recognition. In the area of computer vision, also referred to as machine vision, the best results have been achieved by training large models with many parameters using large amounts of training data. Providing the human annotations required for supervised learning is time-consuming and costly, however. This means that typically only a small portion of the available data is labeled. Therefore, recent work has focused on the use of unlabeled data for the pre-training of backbone models.

One way to make use of unlabeled data is self-supervised learning, which aims to build background knowledge and a kind of common sense in AI models before fine-tuning the model for a specific downstream task. In self-supervised learning, the model receives monitoring signals from the data itself, often to predict the same feature space for different views (or augmentations) of the same image. To generate identical embeddings of an object independent of the view, the model has to learn semantic information about that specific object (object understanding). Conventional methods are described in SimSiam [1] and Dino [2](references are provided at the end of the description for easier reference).

### SUMMARY

The present invention relates to a method, a machine learning model, a computer program, a device, and a computer-readable storage medium. Features and details of the present invention will emerge from the description herein and the figures. Features and details which are described in connection with the method according to the present invention will of course also apply in connection with the machine learning model according to the present invention, the computer program according to the present invention, the device according to the present invention, and the computer-readable storage medium according to the present invention and vice versa, so that mutual reference is or can always be made with respect to the disclosure of the individual aspects of the present invention.

The subject matter of the present invention is in particular a method for training a machine learning model for semantic scene understanding. Semantic scene understanding can refer to the ascertainment of semantic scene information, i.e., preferably a classification of image information with respect to information about the scene represented therein. In other words, the image information is in particular used to train an understanding of the scene.

According to an example embodiment of the present invention, the method can initially comprise providing training data. The training data can comprise image information that represents a specific scene of the surroundings. The scene is a traffic scene in the surroundings of a vehicle, for example, or some other scene in the vicinity of a device. It is possible that the scene changes over time and/or the surroundings change, e.g., as the vehicle/device is moving. It is therefore possible that, in addition to the image information for representing a scene, the training data also includes image information for other scenes that represents the other scenes of the one or more surroundings. In this case, it can be essential that multiple pieces of image information, in particular multiple images, are provided for each scene that show the (same) surroundings, possibly from different perspectives and/or with different views. The images can result from different image sensor sources, which in particular acquire the (same) surroundings with different views/perspectives.

With the method of the present invention, it is also possible that the image information results from a variety of image sensor sources in order to show the surroundings with different views in the image information for the representation of the respective scene. This means in particular that the image information comes from different image sensor sources, such as real or simulated cameras, that depict the (same) surroundings, but with a different view and/or camera configuration and/or perspective and/or orientation and/or different field of view. The image sensor sources can, for example, include: cameras, vehicle cameras, CMOS sensors, CCD sensors, infrared sensors, ultrasonic sensors, radar sensors, LiDAR sensors, thermographic sensors and other types of optical sensors.

According to an example embodiment of the present invention, the method can also comprise training the machine learning model on the basis of the provided training data to ascertain semantic scene information. For this purpose, the image information can be used to evaluate the surroundings in accordance with the different views in order to ascertain and in particular identify the semantic scene information. In other words, the depiction can be evaluated in accordance with the different views, i.e. in particular from a plurality of depictions for representing the scene with different views.

According to an example embodiment of the present invention, the method can also comprise providing the trained machine learning model; for example for use to ascertain the semantic scene information in a vehicle or another device.

One underlying idea of the present invention is in particular the manner, in particular the modality, in which data from a vehicle with multiple cameras or a device with multiple cameras are generally fed into a machine learning model, such as a Siamese network, for self-supervised learning. In contrast to conventional solutions that use self-supervised learning methods for computer vision (such as SimSiam [1] or Dino [2]) in which different views of an object are created from the same image (by cropping and augmentation), the present invention takes advantage of using different images of the same scene taken by different cameras, for example of a test vehicle. This not only promotes the learning of object features, but also the learning of semantic information about the specific scenes and surroundings.

A scene can in particular be understood to be information from an image of the surroundings that serves to provide a description of the current surroundings. In other words, a scene can be described by an image of the surroundings that provides important information about the current surroundings.

Information about the location, a context such as a freeway, as well as information about the weather and weather conditions, for instance, can be provided as scene information. The time of day can be important, as well, and thus be provided as scene information.

According to an example embodiment of the present invention, the machine learning model, in particular at least one network, can be trained to bring the different views to the same feature space in order to ascertain the semantic scene information. This makes it possible to improve contextual understanding.

In the context of the present invention it can further be provided that the image information is specifically for the acquisition of the different views of the surroundings using different image sensors, in particular cameras, and/or results from acquisition by the different image sensor sources in the form of the different image sensors. Different images with different views of the same surroundings can thus be provided as the image information to represent the same scene and used for the training. This in particular makes it possible to improve scene understanding and reduce the effort required, for example for manual annotation.

According to an example embodiment of the present invention, it can optionally be provided that the image information comprises different images in which the views of the same surroundings differ in that an image angle and/or a viewing angle are different. A further advantage in the context of the invention can be achieved if the image sensor sources comprises at least one wide-angle front camera and/or at least one telephoto front camera and/or at least one side camera and/or at least one rear camera, in particular of a vehicle, in order to provide at least one and/or different zoom sections and/or image sections and/or overlaps for representing the scene in the image information. The cameras can be attached to a vehicle, such as a motor vehicle, in order to monitor the surroundings while driving and, for instance, to provide the monitoring for a driving function for automated and/or autonomous driving.

According to an example embodiment of the present invention, it is also advantageous if the image sensor sources are embodied as cameras of a vehicle, so that the image information for representing the respective scene is provided in the form of a traffic scene. This makes it possible to detect hazards in road traffic and/or provide a driving function for automated and/or autonomous driving. The vehicle can be a motor vehicle and/or a passenger vehicle and/or an autonomous vehicle, for instance. The vehicle can comprise a vehicle device, for example for providing an autonomous driving function, and/or a driver assistance system. The vehicle device can be configured to at least partially automatically control and/or accelerate and/or brake and/or steer the vehicle.

In the context of the present invention, it can also be provided that the machine learning model is trained for ascertaining and in particular classifying the semantic scene information on the basis of image points, in particular pixels, of the image information. This makes it possible to obtain a description of the surroundings from the image information; preferably relating to a context and/or weather conditions and/or a time of day and/or a traffic situation. The machine learning model is in particular trained for classification and/or object detection in order to be able to reliably ascertain the semantic scene information based on the image information. The training can therefore result in a trained machine learning model that can be used for this purpose. The use, and with it the inference, can be provided in a vehicle, for example, or in another device. The data points of the training data and/or (in the case of inference) the input data of the machine learning model can be pixels of image information, for example, in particular image data, or be based these in order to then carry out the classification and/or object detection of the data points on the basis of the pixels. The image information can include sensor and/or image data that results at least in part from acquisition by means of a sensor, preferably a camera sensor, and/or which have been at least partially synthesized, i.e. in particular mimic the real data of a sensor. Specifically, it can be provided that the surroundings of a sensor and/or a vehicle and/or a traffic scene are represented by the values of image points, preferably pixels, of the image data. Classification, preferably image classification and/or object detection, based on of these values can be provided. This makes it possible to detect scene information and/or objects of the traffic scene, for instance. Classification can also be provided in the form of semantic segmentation (i.e. a pixel-by-pixel or area-by-area classification). The image data can be images from a radar sensor and/or an ultrasonic sensor and/or a LiDAR sensor and/or a thermal imaging camera, for example. The images can therefore also be embodied as radar images and/or ultrasound images and/or thermal images and/or LiDAR images.

According to an example embodiment of the present invention, it is also possible for the depiction to be evaluated in accordance with the different views by aligning the depictions at the feature level, in particular by minimizing a distance calculation (e.g. cosine similarity), in order to ascertain the semantic scene information. A distance calculation can be minimized by transforming the feature vectors of the depictions into a common feature space, for example. Distance calculation is in particular intended to be understood to mean calculating the similarity between the feature vectors of the depictions. In this context, a cosine similarity can be used to calculate the similarity between the feature vectors. The cosine similarity is a measure of the similarity of two feature vectors. This involves determining the cosine of the angle between the vectors, for example.

it is also possible that the machine learning model comprises at least or exactly two submodels-preferably in parallel paths- and/or is configured with a teacher-student architecture and/or as a Siamese network. The training of the machine learning model can also include:
feeding image information resulting from acquisition by a first camera type, preferably a wide-angle front camera, and/or augmentations of said image information into a first model of the machine learning model, preferably a teacher model,
feeding image information resulting from acquisition by a second camera type, preferably a telephoto, side, or even rear camera, and/or augmentations of said image information into a second model of the machine learning model, preferably a student model.

Another subject matter of the present invention is a machine learning model, which has been trained by a method according to the present invention. The machine learning model according to the present invention thus has the same advantages as those described in detail with reference to a method according to the present invention.

Another subject matter of the present invention is a computer program, in particular a computer program product, comprising instructions that, when the computer program is executed by a computer, prompt the computer program to carry out the method according to the invention. The computer program according to the present invention has the same advantages as those described in detail with reference to a method according to the present invention.

The present invention also relates to a device for data processing which is configured to carry out the method according to the present invention. The device can be a computer, for example, that executes the computer program according to the present invention. The computer can comprise at least one processor for executing the computer program. A non-volatile data memory in which the computer program can be stored and from which the computer program can be read by the processor for execution can be provided as well. The device can also be configured as a control unit for a vehicle.

The present invention can also relate to a computer-readable storage medium, which comprises the computer program according to the present invention and/or instructions that, when executed by a computer, prompt the computer program to carry out the method according to the present invention. The storage medium is configured as a data memory such as a hard drive and/or a non-volatile memory and/or a memory card, for example. The storage medium can be integrated in the computer, for instance.

The method according to the present invention can moreover also be configured as a computer-implemented method.

Further advantages, features, and details of the present invention will emerge from the following description, in which embodiment examples of the invention are described in detail with reference to the figures. The features mentioned in the disclosure herein can each be essential to the present invention individually or in any combination.

### BRIEF DESCRIPTION OF THE DRAWINGS

FIG. 1 shows a schematic visualization of a method, a device, a storage medium and a computer program according to embodiment examples of the present invention.

FIG. 2 shows a schematic visualization of a machine learning model according to embodiment examples of the present invention.

FIG. 3 shows a schematic illustration of a vehicle with cameras.

### DETAILED DESCRIPTION OF EXAMPLE EMBODIMENTS

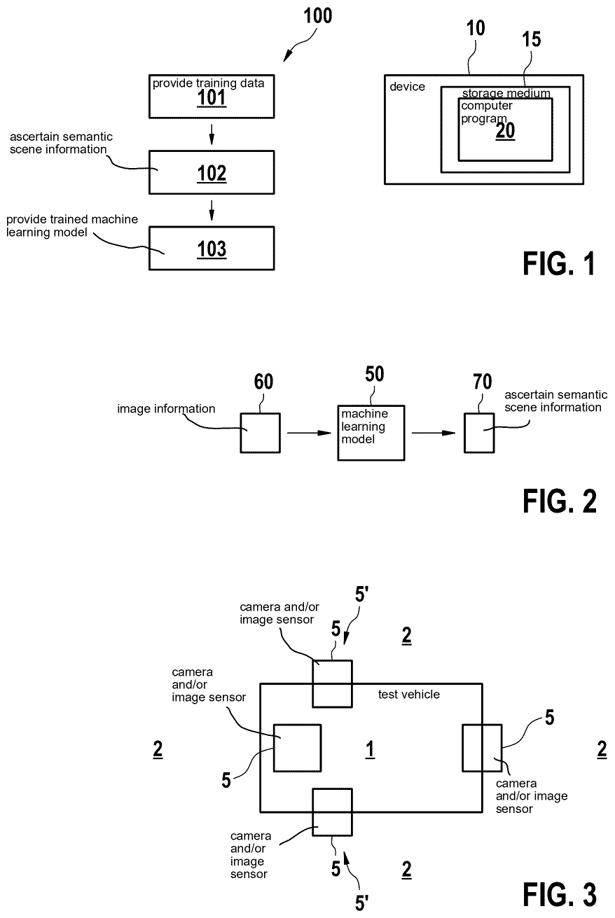

FIG. 1 schematically shows a method 100, a device 10, a storage medium 15 and a computer program 20 according to embodiment examples of the invention. This illustrates the method 100 for training a machine learning model 50 for semantic scene understanding visualized in FIG. 2. According to a first method step 101, training data is provided and the training data comprise image information 60 that represents a respective scene of the surroundings 2 (see also FIGS. 2 and 3).

As shown in FIG. 3, the image information 60 can result from a variety of image sensor sources 5 in order to show the surroundings 2 with different views in the image information 60 for the representation of the respective scene.

According to FIGS. 1 and 2, the machine learning model 50 is trained in a second method step 102 on the basis of the provided training data to ascertain semantic scene information 70. Then, according to a third method step 103, the trained machine learning model 50 can be provided 103.

As illustrated as an example in FIG. 3, the image information 60 can be specifically for the acquisition of the different views of the surroundings 2 using different image sensors 5, in particular cameras 5, and/or result from acquisition by the different image sensor sources 5 in the form of the different image sensors 5. Thus, different images 60 with different views of the same surroundings 2 can be provided as the image information 60 to represent the same scene and used for the training 102. Specifically, the image information 60 can comprise different images 60 in which the views of the same surroundings 2 differ in that an image angle and/or a viewing angle are different. This can be seen in FIG. 3 with the two laterally disposed cameras 5′, for example. The shown cameras 5, 5′, are embodied as a wide-angle front camera and/or a telephoto front camera and/or a side camera and/or a rear camera of a vehicle 1, for instance.

According to embodiment examples, the present invention further comprises a self-supervised learning paradigm for semantic scene understanding. In other words, in contrast to semantic object understanding as provided in conventional methods, the method 100 according to design variants of the invention, can enable semantic scene understanding. For this purpose, in particular multiple images 60 taken by different cameras 5 of the same test vehicle 1 can be fed into a Siamese network. The machine learning model 50 can thus be trained to learn semantic information about the current scene in order to map the different camera views to the same embedding.

A Siamese network is in particular understood to be a machine learning model 50 in which two or more identical neural networks (“twins”) are trained in parallel to accomplish a common task. In other words, the twins are submodels in parallel paths. The Siamese network can have the following structure: An input layer can be provided. This input layer of the network can receive the input data and forward it to the next layer. A processing layer can have multiple layers of neurons that process the input data and extract features from them. An example number of neurons for the stated purpose is 128 and will depend, among other things, on how complex the input data are and how many features are to be extracted. The linking layer can connect the identical networks with one another by comparing the features from the processing layers and outputting a similarity score. The output layer can output the result of the network based on the common task that the identical networks have trained in parallel.

A loss function can also be provided as a critical part of a Siamese network. It measures how well the network recognizes the similarity or dissimilarity of the input data. One possible loss function for the invention is the cross-entropy loss function.

According to embodiment examples of the present invention, it can be particularly advantageous to use cameras 5 having different image angles and/or viewing angles. A combination of a wide-angle front camera, a telephoto front camera and additional side cameras and/or even rear cameras can be used, for instance. This creates zoom sections and also overlaps and unique image sections.

Design variants of the invention make it possible to use self-supervised learning to enable both semantic understanding of scenes and pre-training on domain-relevant data.

In a method 100 according to design variants of the present invention, it can be provided that a test vehicle 1 is equipped with a plurality of image sensor sources 5 in the form of video cameras 5 that record a varied and comprehensive image of the surroundings 2. The test vehicle 1 can then be used to collect image information 60 in the form of video data 60 of important and complex scenes. In doing so, it is particularly useful to collect data from scenes and areas that fit within the area of application of the model (e.g. to enable range adjustment).

After data collection, a Siamese network can be trained using a self-supervised learning technique. It can be advantageous to use one of the proven methods such as SimSiam [1] or Dino [2] for this purpose (see references at the end of the description).

When using Dino [2], for example, the teacher model (teacher) can be fed with images from the wide-angle front camera (or extensions of these images), while the student (or also student model) is fed with images from the telephoto, side or even rear camera (or extensions of these images).

Both the teacher and student embeddings can be fed into a cross-entropy loss to adapt the latent space of the various camera views to one another. In other words, a function such as a cross-entropy loss can be used to ascertain the difference between the actual and the predicted probability distribution. The cross-entropy loss function in particular calculates the difference between the actual probability distribution and the probability distribution predicted by the model.

It can then be provided that only the student is updated, while the parameters of the teacher are calculated by an exponential moving average of the student parameters.

It is possible that the distribution of the different cameras varies between student and teacher. For example, it is necessary to evaluate which camera images are best fed to the student and which to the teacher. However, it may be advantageous if the images of the teacher contain a comparatively large amount of information about the current scene. It can also be advantageous to supplement, i.e. in particular augment, the images; e.g. with random sections and color distortions.

The above explanation of the example embodiments describes the present invention solely within the scope of examples. Of course, individual features of the example embodiments can be freely combined with one another, if technically feasible, without leaving the scope of the present invention.
[1] Xinlei Chen and Kaiming He. Exploring Simple Siamese Representation Learning. 2020.
[2] Mathilde Caron, Hugo Touvron, Ishan Misra, Herve Yegou, Julien Mairal, Piotr Bojanowski, and Armand Joulin. Emerging Properties in Self-Supervised Vision Transformers. 2021.

What is claimed is:

1. A method for training a machine learning model for semantic scene understanding, comprising the following steps:
providing training data, wherein the training data include image information that represents a respective scene of the surroundings, wherein the image information results from a variety of image sensor sources in order to show the surroundings with different views in the image information for the representation of the respective scene;
training the machine learning model based on the provided training data to ascertain semantic scene information, for which purpose a depiction is evaluated in accordance with the different views; and
providing the trained machine learning model.

2. The method according to claim 1, wherein the image information is specifically for: (i) acquisition of the different views of the surroundings using different image sensors, the different image sensors including cameras and/or (ii) results from acquisition by the different image sensor sources in the form of the different image sensors, so that different images with different views of the same surroundings are provided as the image information to represent the same scene and used for the training.

3. The method according to claim 1, wherein the image information includes different images in which the views of the same surroundings differ in that an image angle and/or a viewing angle are different.

4. The method according to claim 1, wherein the image sensor sources include: at least one wide-angle front camera of a vehicle and/or at least one telephoto front camera of the vehicle and/or at least one side camera of the vehicle and/or at least one rear camera of the vehicle, in order to provide at least one and/or different zoom sections and/or image sections and/or overlaps for representing the scene in the image information.

5. The method according to claim 1, wherein the image sensor sources are embodied as cameras of a vehicle so that the image information for representing the respective scene is provided in the form of a traffic scene.

6. The method according to claim 1, wherein the machine learning model is trained to ascertain and classify the semantic scene information based on image points including pixels of the image information in order to obtain a description of the surroundings from the image information, elating to a context and/or weather conditions and/or a time of day and/or a traffic situation, wherein the depiction is evaluated in accordance with the different views by aligning the depictions at the feature level, by minimizing a distance calculation in order to ascertain the semantic scene information.

7. The method according to claim 1, wherein the machine learning model includes at least or exactly two submodels in parallel paths and is configured with a teacher-student architecture and/or as a Siamese network, wherein the training of the machine learning model includes:
feeding image information resulting from acquisition by a first camera type including a wide-angle front camera, and/or augmentations of the image information into a first model of the machine learning model including a teacher model,
feeding image information resulting from: (i) acquisition by a second camera type including a telephoto, or side, or rear camera, and/or (ii) augmentations of the image information into a second model of the machine learning model including a student model.

8. A machine learning model which has been trained for semantic scene understanding, the machine learning model being trained by:
providing training data, wherein the training data include image information that represents a respective scene of the surroundings, wherein the image information results from a variety of image sensor sources in order to show the surroundings with different views in the image information for the representation of the respective scene;
training the machine learning model based on the provided training data to ascertain semantic scene information, for which purpose a depiction is evaluated in accordance with the different views; and
providing the trained machine learning model.

9. A device for data processing, which is configured to train a machine learning model for semantic scene understanding, the device being configured to:
provide training data, wherein the training data include image information that represents a respective scene of the surroundings, wherein the image information results from a variety of image sensor sources in order to show the surroundings with different views in the image information for the representation of the respective scene;
train the machine learning model based on the provided training data to ascertain semantic scene information, for which purpose a depiction is evaluated in accordance with the different views; and
provide the trained machine learning model.

10. A non-transitory computer-readable storage medium on which are stored instructions for training a machine learning model for semantic scene understanding, the instructions, when executed by a computer, causing the computer to perform the following steps:
providing training data, wherein the training data include image information that represents a respective scene of the surroundings, wherein the image information results from a variety of image sensor sources in order to show the surroundings with different views in the image information for the representation of the respective scene;
training the machine learning model based on the provided training data to ascertain semantic scene information, for which purpose a depiction is evaluated in accordance with the different views; and
providing the trained machine learning model.
